(19) United States
(12) Patent Application Publication
(10) Pub. No.: US 2006/0278177 A1
(43) Pub. Date: Dec. 14, 2006

(54) Apparatus for blind pets

(76) Inventor: Wendy M. Crawford, Los Osos, CA (US)

Correspondence Address: Andrew Y. Schroeder, Suite 222, 500 S. Broadway, Santa Maria, CA, 93454, US

(21) Appl. No.: 11/149,634

(22) Filed: Jun. 9, 2005

(51) Int. Cl. A01K 13/00

(52) U.S. Cl. 119/850

(57) ABSTRACT

An apparatus for blind pets comprising a hood region and a harness region; the hood region being convex-shaped and comprising a foam material and a rigid plate, foam material being affixed to the rigid plate with affixing means; the foam material and the rigid plate being covered with a fabric material; the hood region detachably secured to harness region by cooperating hooks material and loops material affixed to both hood region and harness region; the harness region comprising a neck collar, a thoracic collar, a ventral bridge, a dorsal bridge, and two elastic bridges, the neck collar for encircling neck region of a blind pet; the thoracic collar for encircling thoracic region of a blind pet; the thoracic collar connected with neck collar via the two elastic bridges, the dorsal bridge, and the ventral bridge.

### FIELD OF THE INVENTION

The present invention is in the area pet accessories and pertains more particularly to methods, apparatus, and articles of manufacture for blind pets.

### BACKGROUND OF THE INVENTION

To date there are no products in the marketplace which protect blind pets from hurting themselves. Blind pets typically experience problems hitting their heads upon various objects within their paths. Blind humans are able to use a cane or a guide dog to navigate and avoid hitting objects in their path.

Without sight many pets experience a panoply of problems. For example, a blind dog may inadvertently run into a wall or other hard objects. In other instances, blind dogs may bump into things in order to orient themselves. Hitting their heads and faces repeatedly over time can cause injury to their eyes, noses and rupture of discs in their necks.

Therefore, what is clearly needed is an apparatus for enabling blind pets to move about with confidence and avoid hurting themselves. Moreover, there is a need in the marketplace for an apparatus that enables blind pets to navigate and feel their way around their homes.

### SUMMARY OF THE INVENTION

An apparatus for blind pets comprising: a hood region and a harness region; said hood region being convex-shaped and comprising a foam material and a rigid plate, said foam material being affixed to said rigid plate with affixing means; said hood region detachably secured to harness region by cooperating hooks material and loops material affixed to both hood region and harness region; said harness region comprising a neck collar, a thoracic collar, a ventral bridge, a dorsal bridge, and two elastic bridges, said neck collar for encircling neck region of a blind pet; said thoracic collar for encircling thoracic region of a blind pet; said thoracic collar connected with neck collar via said two elastic bridges, said dorsal bridge, and said ventral bridge.

The apparatus in some preferred embodiments may incorporate at least one releasable buckle. The apparatus may also in some preferred embodiments possess a thoracic collar which further incorporates at least one tri-slide.

The apparatus for blind pets in some preferred embodiments has elastic bridges which further incorporates at least one tri-slide. The apparatus in other preferred embodiments possesses a neck collar which further comprises a coupling ring for connecting ventral bridge with two distal ends of said neck collar. The apparatus in some preferred harness material is made of nylon. In other preferred embodiments the harness material is made of leather or of a polymer material such as vinyl or plastic. The apparatus for blind pets in some preferred embodiments possesses harness material which is made of rubber. In some preferred embodiments the hood region further comprises a fabric material or plastic coating for covering the rigid plate and foam material.

The present invention also includes a method of placing the apparatus for blind pets onto blind pet comprising the steps of:
(a) placing said neck collar over and onto neck of pet while leaving said releasable buckles unconnected;
(b) placing thoracic collar over thoracic region of blind pet by connecting opposite ends of said releasable buckles.

The apparatus for blind pets may further incorporate a leash connected with the neck collar. The apparatus for blind pets may, in some preferred embodiments be made of nylon.

### BRIEF DESCRIPTION OF THE DRAWING FIGURES

FIG. 1 is a perspective view of an exemplary system according to an embodiment of the present invention.

FIG. 2 is a perspective view of an exemplary preferred embodiment of the present invention.

FIG. 3 is a perspective view of an exemplary preferred embodiment of the present invention.

FIG. 4 is a cross-sectional view of an exemplary preferred embodiment of the present invention.

FIG. 5 is a perspective view of an exemplary preferred embodiment of the present invention.

FIG. 6 is a perspective view of an exemplary preferred embodiment of the present invention.

FIG. 7 is a perspective view of an exemplary preferred embodiment of the present invention.

FIG. 8 is a perspective view of an exemplary preferred embodiment of the present invention.

FIG. 9. is a perspective view of an exemplary preferred embodiment of the present invention.

### DESCRIPTION OF PREFERRED EMBODIMENTS

According to a preferred embodiment of the present invention, a unique article of manufacture, apparatus, and methods thereof are used to enable blind pets to navigate about without hurting themselves. The present invention is described in enabling detail below.

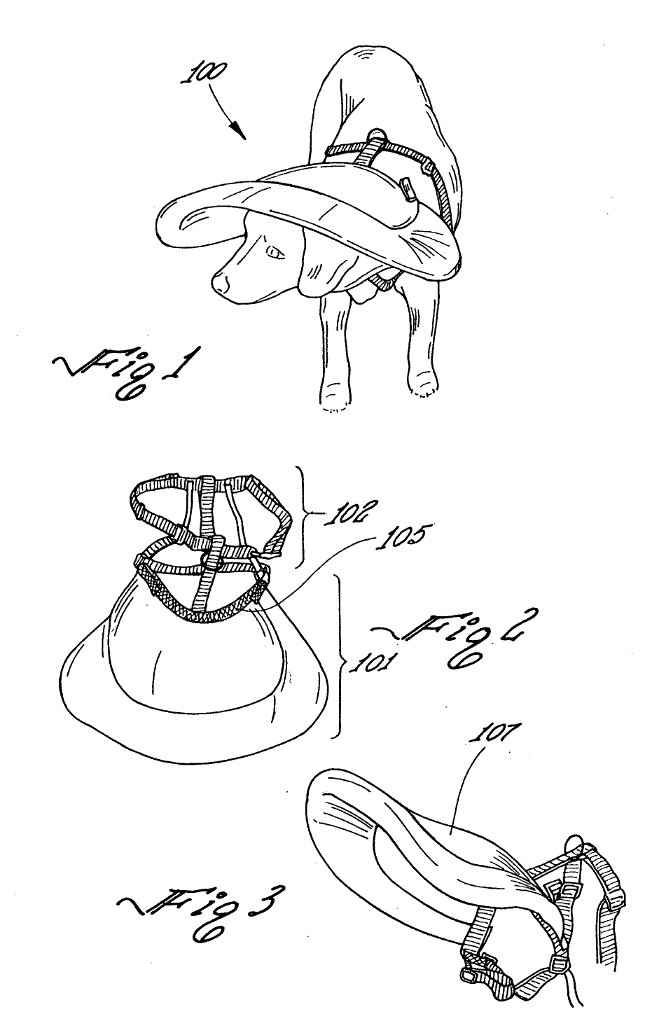

FIG. 1 is a perspective view of a preferred embodiment of the present invention. Blind pet apparatus 100 comprises two main regions which will hereinafter be referred to as hood region 101 and harness region 102.

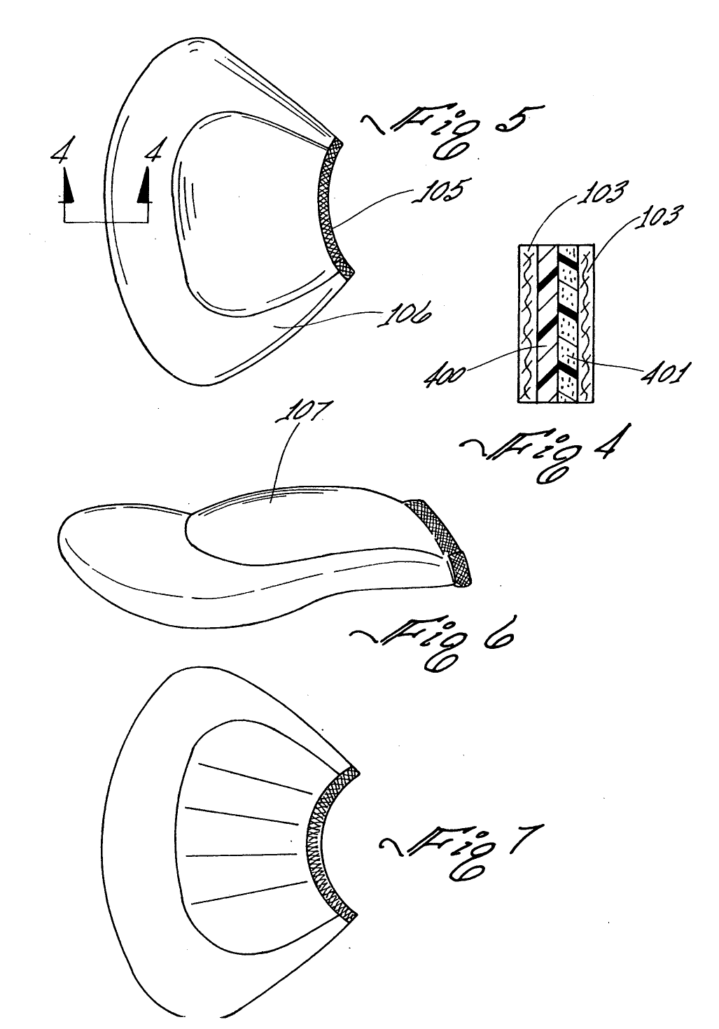

Hood region 101 comprises a convex-shaped article of manufacture. FIG. 4 shows the cross-sectional view of hood region 101. The cloth material 103 covers both the plastic 125 and the foam material 127. However, it is, not specifically required that interior portion of hood region 101 comprise foam. Other equally expedient materials may be interchangeably used which accomplishes the same functions as the foam. The reason foam was used in the present preferred embodiment is that it is resilient and lightweight. For this reason other materials such as rubber, plastic, polymer, cardboard, and aluminum may be equally expedient for the purpose of filling out the skeletal structure of the hood region 101.

Likewise, it is not specifically required that a hard plastic material be used to comprise the hood region 101. The reason the hard plastic material was used to comprise hood region 101 was because it is lightweight, durable and strong enough to give the hood region 101 the rigidity to comprise the skeleton of the hood region 101. For this reason, other fungible materials which achieve the same purpose of the hard plastic material may also be used. Examples include polymers, wood, rubber, cardboard, aluminum and other lightweight rigid materials expedient for said uses.

In order to properly make the skeletal portion of hood region 101 the foam must be glued to the hard plastic material. Thereafter, cloth material 103 is used to cover the foam/hard plastic material. Cloth material 103 in a preferred embodiment is stitched onto the skeletal material in order to provide a smooth and tight fit. However, it is not specifically required that the means of affixing cloth material 103 to skeletal material necessarily be via stitching or sewing. Other affixing means may prove equally expedient for such use. Furthermore, the details of affixing cloth material 103 shall not be detailed herein further because the means are well known to one skilled in the art. It is not essential that cloth be used to cover the foam and plastic. For instance, two lightweight pieces of plastic-coated foam could be fused together with the plastic dome in between them.

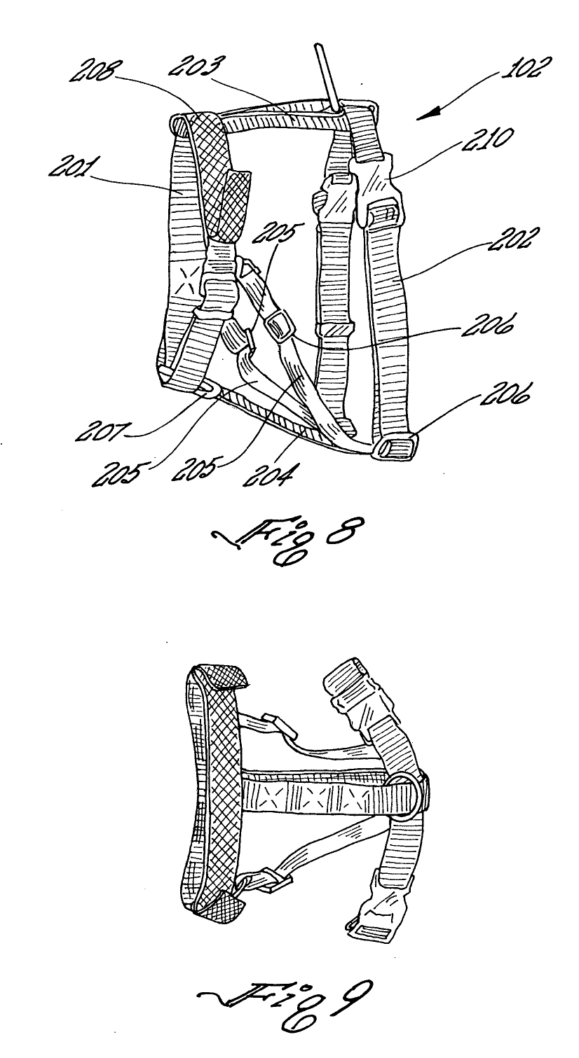

Referring now to FIGS. 5, 6, and 7, in a preferred embodiment, a VELCRO® (a trademarked material) lining 104 with cooperating hooks material and loops material is affixed to the harness edge 105 of the hood region 101. It is of no consequence which side of the VELCRO® region is used. In a preferred embodiment of the present invention, the VELCRO® lining extends along the length of the underside 106 of the hood region 101. For purposes of clarity underside 106 is meant to be the side of the hood region 101 which comes into direct contact with the head of the pet. The upper portion 107 of hood region 101 also has a VELCRO® lining 104 affixed thereto.

FIG. 2 shows a perspective view of the harness region 102 according to a preferred embodiment of the present invention. Most of the harness region 102 is composed of either a nylon or leather material in a preferred embodiment. However, it is not specifically required that either nylon or leather be used to compose the harness region. Other equally expedient materials abound which may achieve the same functions and features may be used which accords with the spirit and scope of the present invention.

Harness region 102 comprises a neck collar 201 connected to a thoracic collar 202 via a dorsal bridge 203, a ventral bridge 204, and two elastic bridges 205. Portions of the harness region 102 are connected with tri-slides 206, and coupling rings 207.

Neck collar 201 has an adjustable circumference to be fitted around the neck of a pet such as a dog. Near the bottom of the neck collar 201 are two tri-slides 206 which enable neck collar 201 to be properly fitted to the exact dimensions of said pet. (For purposes of clarity, top shall hereinafter refer to the region closest to the dorsal bridge 203, and bottom shall hereinafter refer to the region nearest the ventral bridge 204). At the very bottom of neck collar 201 is a coupling ring 207. Coupling ring 207 joins the ventral bridge 204 with the two distal ends of neck collar 201. Affixed to top portion of the neck collar 201 is a VELCRO® strip 208. VELCRO® strip 208 is used to affix neck collar 201 with hood region 200. Also attached with neck collar 201 are two elastic bridges 205. The two elastic bridges 205 connect the neck collar 201 with the thoracic collar 202. And both elastic bridges 205 incorporate one tri-slide 206 each to enable the elastic bridges 205 to be flexible.

The thoracic collar 202 has a circumference such that it can wrap around the thoracic cavity of the pet. (Thoracic cavity shall hereinafter refer to the region around the rib cage of a pet) Thoracic collar 202 incorporates the use of two tri-slides 206 as well as two releasable buckles 210. The two releasable buckles 210 are located substantially near the dorsal end whereas the two tri-slides 206 are located substantially near the ventral end of the thoracic collar 202.

Blind pet apparatus 100 is fitted around the blind pet by simply placing the neck collar 201 over and onto the neck of the pet while making sure that the two releasable buckles 210 are already unconnected. After the neck collar 201 is snugly placed onto the pet, the thoracic collar 202 is placed over the pet by simply connecting opposite ends and locking them near the dorsal portion with the two releasable buckles 210.

It will be apparent to the skilled artisan that there are numerous changes which may be made in embodiments described herein without departing from the spirit and scope of the invention. Other features not mentioned in the specification, but known to one skilled in the art may be integrated as well without departing from the spirit and scope of the present invention. There are, for example, a wide array of materials, apparatuses, and methods which may be interchangeably used, there are many changes that may be made in dimensions and so forth to accommodate different needs which may be used, all within the scope of the invention. For instance, the neck collar may further include a connection with a leash. The apparatus, article of manufacture, and methods used thereof should be afforded the broadest possible scope under examination. As such, the invention taught herein by specific examples is limited only by the scope of the claims that follow.

What is claimed is:

1. An apparatus for blind pets comprising:
a hood region and a harness region;
said hood region being convex-shaped and comprising a foam material and a rigid plate,
said foam material being affixed to said rigid plate with affixing means;
said hood region detachably secured to harness region by cooperating hooks material and loops material affixed to both hood region and harness region;
said harness region comprising a neck collar, a thoracic collar, a ventral bridge, a dorsal bridge, and two elastic bridges, said neck collar for encircling neck region of a blind pet;
said thoracic collar for encircling thoracic region of a blind pet;
said thoracic collar connected with neck collar via said two elastic bridges, said dorsal bridge, and said ventral bridge.

2. The apparatus for blind pets of claim 1 wherein said thoracic collar incorporates at least one releasable buckle.

3. The apparatus for blind pets of claim 2 wherein said thoracic collar further incorporates at least one tri-slide.

4. The apparatus for blind pets of claim 1 wherein said elastic bridges further incorporates at least one tri-slide.

5. The apparatus for blind pets of claim 1 wherein neck collar further comprises a coupling ring for connecting ventral bridge with two distal ends of said neck collar.

6. The apparatus for blind pets of claim 1 wherein the harness material is made of nylon.

7. The apparatus for blind pets of claim 1 wherein the harness material is made of vinyl.

8. The apparatus for blind pets of claim 1 wherein harness material is made of leather.

9. The apparatus for blind pets of claim 2 wherein harness material is made of leather.

10. The apparatus for blind pets of claim 1 wherein harness material is made of rubber.

11. The apparatus for blind pets of claim 2 wherein harness material is made of rubber.

12. The apparatus for blind pets of claim 1 wherein hood region further comprises a fabric material for covering said rigid plate and said foam material.

13. The apparatus for blind pets of claim 2 wherein hood region further comprises a fabric material for covering said rigid plate and said foam material.

14. The apparatus for blind pets of claim 1 wherein hood region further comprises a plastic coating for covering said rigid plate and said foam material.

15. The apparatus for blind pets of claim 2 wherein hood region further comprises a plastic coating for covering said rigid plate and said foam material.

16. The apparatus for blind pets of claim 1 wherein affixing means is glue.

17. A method of placing the apparatus for blind pets of claim 2 onto blind pet comprising the steps of:
a. placing said neck collar over and onto neck of pet while leaving said releasable buckles unconnected;
b. placing thoracic collar over thoracic region of blind pet by connecting opposite ends of said releasable buckles.

18. The apparatus for blind pets of claim 1 further including a leash connected with neck collar.

19. The apparatus for blind pets of claim 10 wherein said leash is made of nylon.

20. The apparatus for blind pets of claim 10 wherein said leash is made of leather.
